(19) United States
(12) Patent Application Publication
(10) Pub. No.: US 2016/0110206 A1
(43) Pub. Date: Apr. 21, 2016

(54) DISPLAY APPARATUS AND CONTROLLING METHOD THEREOF

(71) Applicant: SAMSUNG ELECTRONICS CO., LTD., Suwon-si (KR)

(72) Inventors: Dong-hun LEE, Suwon-si (KR); Sung-hyuk KWON, Suwon-si (KR); Sang-jin HAN, Gunpo-si (KR)

(21) Appl. No.: 14/848,700

(22) Filed: Sep. 9, 2015

(30) Foreign Application Priority Data
Oct. 17, 2014 (KR) 10-2014-0141112

(51) Int. Cl. G06F 9/44; H04N 5/44; G06F 3/0354; G06F 3/0484

(52) U.S. Cl. CPC G06F 9/4446; G06F 3/04845; H04N 5/4403; G06F 3/03547

(57) ABSTRACT

A display apparatus is provided. The display apparatus includes a communicator configured to perform communication with a remote control apparatus having a touch pad, a display configured to display a first GUI corresponding to a touch input on the touch pad, and a controller configured to, in response to receiving location information of the touch input, provide a visual feedback via the first GUI to guide an executable touch interaction at a corresponding touch location based on the received location information.

### CROSS-REFERENCE TO RELATED APPLICATIONS

This application is based on and claims priority under 35 U.S.C. §119 to Korean Patent Application No. 10-2014-0141112, filed in the Korean Intellectual Property Office on Oct. 17, 2014, the disclosure of which is incorporated herein by reference in its entirety.

### BACKGROUND

1. Field

Aspects of the example embodiments relate to a display apparatus and a controlling method thereof, and more particularly, to a display apparatus which is controllable by a remote control apparatus and a controlling method thereof

2. Description of Related Art

With the development of electronic technologies, various types of electronic products have been developed and distributed. In particular, various display apparatuses such as TV, mobile phone, PC, notebook PC, PDA, tablet PC, etc. have been widely used in general households.

As the number of display apparatuses used has increased, there is a growing need for various input methods for using various functions of a display apparatus efficiently. For example, an input method using a remote controller, an input method using a mouse, an input method using a touch pad, etc. have been applied to a display apparatus.

However, it is difficult for a user to use the various functions of a display apparatus efficiently using such a simple input method. For example, if a display apparatus is configured such that all functions of the display apparatus are controlled by a remote controller, it is inevitable that the number of buttons on the remote controller will increase, making it difficult for a user to find and manipulate a right button out of many buttons for a desired function.

In order to resolve the above problem, a remote controller with a touch pad has been recently introduced. The remote controller with a touch pad may reduce the number of buttons and allow a user to perform manipulation intuitively.

However, there may be various ways for a user to manipulate a touch pad, and the functions of a display apparatus corresponding to the manipulations of a touch pad cannot be displayed on the remote controller. Consequently, only simple functions which can be recognized intuitively have been used in the related art remote controller with a touch pad, and various manipulations of the touch pad have not been utilized sufficiently.

### SUMMARY

An aspect of the example embodiments relates to a display apparatus which provides a visual feedback to guide a user to an executable touch interaction at the user's touch location using a touch pad of a remote control apparatus and a controlling method thereof

According to an example embodiment, there is provided a display apparatus including a communicator configured to perform communication with a remote control apparatus having a touch pad, a display configured to display a first GUI corresponding to a touch input on the touch pad, and a controller configured to, in response to receiving location information of the touch input, provide a visual feedback to the first GUI to guide a user to an executable touch interaction at a corresponding touch location based on the received location information.

The controller may provide visual feedback by changing at least one of a shape and a color of the first GUI according to at least one of whether a touch interaction is allocated at the touch location and what type of touch interaction is allocated at the touch location.

The controller may control the display to display a second GUI to guide a user to the touch location on the touch pad and display the first GUI inside the second GUI based on location information of the touch input.

The second GUI may correspond to a shape of the touch pad.

The controller, in response to determining that the touch location is within the touch pad, may indicate that a first touch interaction is available, and in response to determining that the touch location is on a border area of the touch pad, provide a visual feedback to the first GUI to indicate that a second touch interaction is available.

The first touch interaction may, for example, be a drag or flick manipulation, and the second touch interaction may be a rotation manipulation.

The controller may control the display to move a location of the second GUI based on a signal corresponding to a movement of the remote control apparatus received from the remote control apparatus, and display the second GUI.

The controller may determine an inputtable function at the touch location based on a type of an object displayed on an area where the second GUI is located, and provide a visual feedback to the first GUI to guide a user to a touch interaction for performing the determined function.

The controller may change a shape of the second GUI based on the determined function, and provide a visual feedback to the first GUI to correspond to the changed second GUI.

The controller, in response to receiving a signal corresponding to a touch interaction input through the remote control apparatus, may perform a function corresponding to the received signal, and provide an animation effect according to the performed function via the first GUI.

According to an example embodiment, there is provided a controlling method of a display apparatus including performing communication with a remote control apparatus having a touch pad, and in response to receiving a signal according to a touch input on the touch pad, displaying a first GUI corresponding to a touch input on the touch pad, and displaying of the first GUI may include providing a visual feedback via the first GUI to guide a user to an executable touch interaction at a corresponding touch location based on location information of the touch input.

Displaying the first GUI may include providing visual feedback by changing at least one of a shape and a color of the first GUI according to at least one of whether a touch interaction is allocated at the touch location and what type of a touch interaction is allocated at the touch location.

The method may further include displaying a second GUI to guide a user to the touch location on the touch pad, and displaying the first GUI may include displaying the first GUI inside the second GUI based on location information of the touch input.

The second GUI may correspond to a shape of the touch pad.

Displaying the first GUI may include, in response to determining that the touch location is within the touch pad, indicating that a first touch interaction is available, and in response to determining that the touch location is on a border area of the touch pad, providing a visual feedback via the first GUI to indicate that a second touch interaction is available.

The first touch interaction may, for example, be a drag or flick manipulation, and the second touch interaction may, for example, be a rotation manipulation.

Displaying the second GUI may include moving a location of the second GUI based on a signal corresponding to a movement of the remote control apparatus received from the remote control apparatus, and displaying the second GUI.

Displaying the first GUI may include determining an inputtable function at the touch location based on a type of an object displayed on an area where the second GUI is located, and providing a visual feedback via the first GUI to guide a user to a touch interaction for performing the determined function.

The method may further include changing a shape of the second GUI based on the determined function, and the displaying the first GUI may include providing a visual feedback via the first GUI to correspond to the changed second GUI.

The method may further include, in response to receiving a signal corresponding to a touch interaction input through the remote control apparatus, performing a function corresponding to the received signal, and providing an animation effect according to the performed function via the first GUI.

According to the above-described various example embodiments, a display apparatus may provide a visual feedback to guide a user to an executable touch interaction at a user's touch location using a touch pad of a remote control apparatus, thereby improving user convenience in using the display apparatus.

### BRIEF DESCRIPTION OF THE DRAWINGS

The above and/or other aspects of the example embodiments will become more apparent from the following detailed description taken with reference to the following drawings in which like reference numerals refer to like elements, and wherein:

FIG. 1 is a view provided to explain an operation of a display apparatus for better understanding of an example embodiment;

FIGS. 2A and 2B are block diagrams illustrating configuration of a display apparatus according to an example embodiment;

FIG. 3 is a screen displaying a GUI according to an example embodiment;

FIGS. 4 and 5 are views illustrating a visual feedback provided to a first GUI according to various example embodiments;

FIGS. 6A and 6B are views provided to explain a method of manipulating a remote control apparatus for better understanding of an example embodiment;

FIG. 7 is a view provided to explain a visual feedback according to an example embodiment;

FIG. 8 is a view provided to explain that a visual feedback is provided from a second GUI according to an example embodiment;

FIG. 9 is a view provided to explain how an object displayed at an area where a second GUI is located is controlled according to an example embodiment;

FIGS. 10A and 10B are views provided to explain a touch interaction according to various example embodiments;

FIG. 11 is a view provided to explain a method of using a touch pad by increasing its usability according to an example embodiment;

FIGS. 12A and 12B are views provided to explain an operation of a second GUI with respect to an object according to various example embodiments;

FIG. 13 is a view illustrating change of a second GUI when there is a delay in time for executing a function according to an example embodiment; and

FIG. 14 is a flowchart provided to explain a method of controlling a display apparatus according to an example embodiment.

### DETAILED DESCRIPTION

Example embodiments of the present disclosure may be diversely modified. Accordingly, specific example embodiments are illustrated in the drawings and are described in detail in the detailed description. However, it is to be understood that the present disclosure is not limited to a specific example embodiment, but includes all modifications, equivalents, and substitutions without departing from the scope and spirit of the present disclosure. Also, well-known functions or constructions are not described in detail since they would obscure the disclosure with unnecessary detail.

Hereinafter, example embodiments will be described in greater detail with reference to the accompanying drawings.

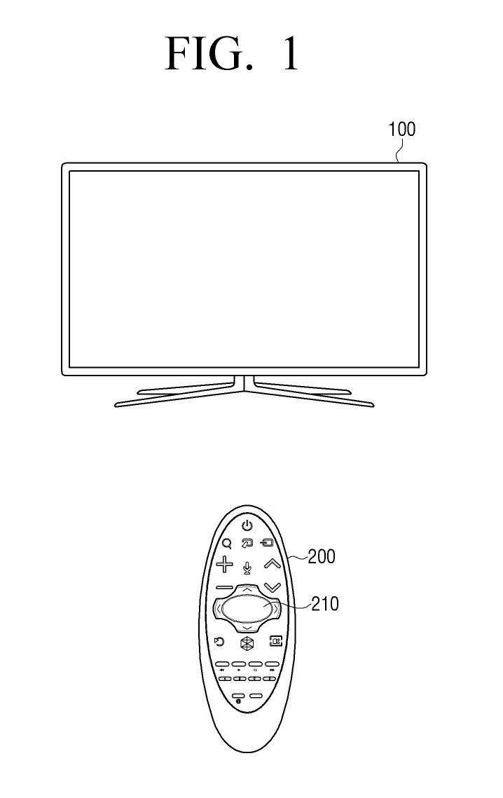

FIG. 1 is a view provided to explain an operation of a display apparatus for better understanding of an example embodiment.

Referring to FIG. 1, a display system according to an example embodiment includes a display apparatus 100 and a remote control apparatus 200.

The display apparatus 100 may, for example, be realized as a digital TV, but is not limited thereto. The display apparatus 100 may be realized as various types of apparatuses with a display function which are controllable by the remote control apparatus 200, such as, for example, a tablet PC, navigation system, etc.

The display apparatus 100 may receive an input signal from the remote control apparatus 200. The input signal received from the remote control apparatus 200 may be an input signal generated by an input of a touch pad 210.

The remote control apparatus 200 may include the touch pad 210. In this case, a user may manipulate the touch pad 210 to execute a desired function. In addition, a user may, for example, control the display apparatus 100 using only the touch pad 210 of the remote control apparatus 200. The user may control the display apparatus 100 using not only the touch pad 210 but also other button manipulations.

If signals corresponding to various manipulation methods of the touch pad 210 are received, the display apparatus 100 may generate different input signals. For example, if a flick manipulation from bottom to top of the touch pad 210 is input, the display apparatus 100 may generate an input signal for channel-up. The function corresponding to the manipulation method of the touch pad 210 may be determined not only by a manufacturer but also by a user. As it is difficult for a user to know various manipulation methods of the touch pad 210 and all of the corresponding functions, a touch interaction type may be provided to the user according to the location information of the user's touch input, which will be described later.

Hereinafter, various example embodiments will be described in detail based on an example configuration of the display apparatus 100.

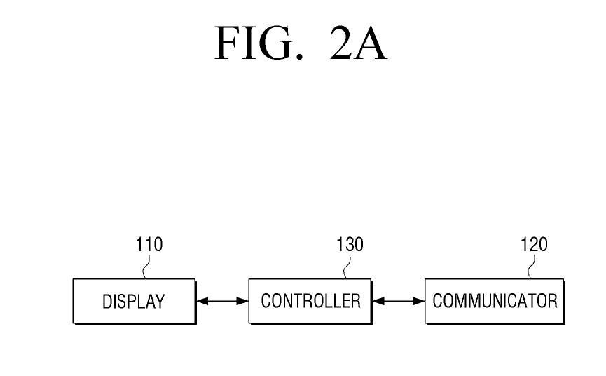

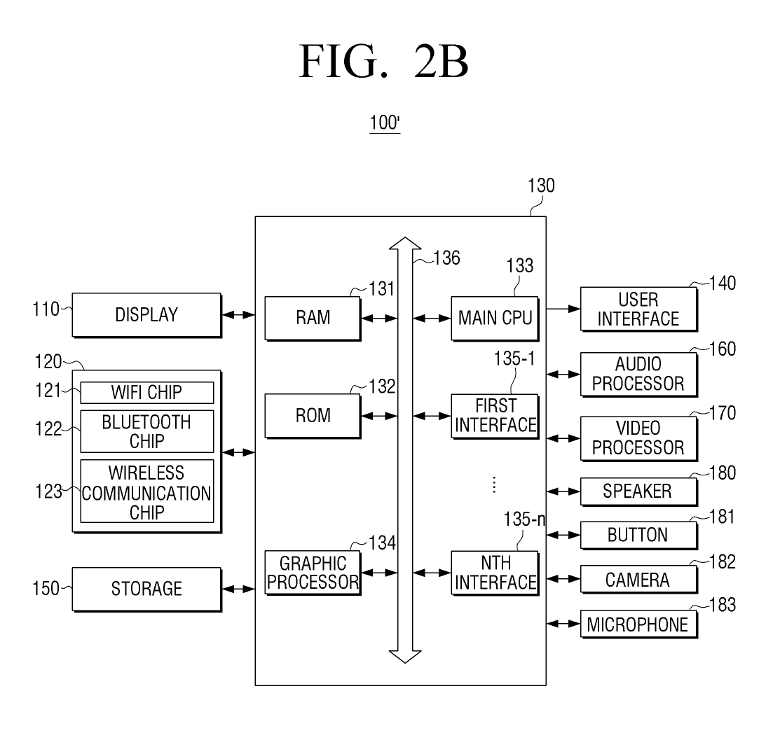

FIG. 2 is a block diagram illustrating a configuration of a display apparatus according to an example embodiment.

Referring to FIG. 2A, the display apparatus 100 includes a display 110, a communicator 120 and a controller 130. For simplicity, FIG. 2A illustrates only elements which involve an operation according to various example embodiments and omits other detailed elements.

The display 110 may display general content, such as, for example, play screen, channel information screen, web content information screen, etc. Each screen may be provided as a UI screen including a GUI icon, but is not limited thereto. Each screen may be provided in the form of thumbnail.

In addition, the display 110 may display various GUIs corresponding to an input signal of the remote control apparatus 200. For example, the display 110 may display a GUI according to a movement of the remote control apparatus 200, or display a GUI corresponding to a touch input of the touch pad 210.

The display 110 may, for example, be realized as Liquid Crystal Display Panel (LCD), Organic Light Emitting Diodes (OLED), etc., but is not limited thereto. In addition, the display 110 may, for example, be realized as flexible display, transparent display, etc. as the case may be.

The communicator 120 performs communication with the remote control apparatus 200.

Specifically, the communicator 120 receives a signal from the remote control apparatus 200. The received signal may be an input signal or a signal which is changed to a control signal. In particular, if the touch pad 210 exists in the remote control signal 200, the received signal may be location information of a user's touch input which is input to the touch pad 210, which will be described later.

Meanwhile, the communicator 120 may perform an unilateral or bilateral communication with respect to the remote control apparatus 200. In the case of unilateral communication, the communicator 120 may receive a signal from the remote control apparatus 200. In the case of bilateral communication, the communicator 120 may receive a signal from the remote control apparatus 200, or transmit a signal to the remote control apparatus 200.

The controller 130 may control the overall operations of the display apparatus 100.

Before providing specific description regarding the controller 130, it is assumed in this specification that a GUI corresponding to a user's touch input is a first GUI and a GUI corresponding to a movement of the remote control apparatus 200 which will be described later is a second GUI for convenience of explanation.

The controller 130 may control the display 110 to display the first GUI corresponding to a touch input on the touch pad 210, and if location information of the touch input is received, provide a visual feedback via the first GUI to guide a user to an executable touch interaction at the corresponding touch location based on the received location information.

The touch interaction may, for example, vary according to a manufacturer of the display apparatus 100 or a user if it is possible for the user to set a touch interaction arbitrarily. In addition, the visual feedback may, for example, be provided by changing the shape of the first GUI. The visual feedback may be provided by providing relevant explanation directly or showing an example using a text and so on.

In addition, the controller 130 may provide a visual feedback by changing, for example, at least one of the shape and color of the first GUI according to at least one of whether a touch interaction is allocated at the touch location and what type of a touch interaction is allocated at the touch location.

The controller 130 may display a second GUI to guide a user to a touch location on the touch pad 210, and display the first GUI inside the second GUI based on the location information of the touch input.

If it is determined that the touch location is within the touch pad 210, the controller 130 may indicate that a first interaction is available, and if it is determined that the touch location is on a border area of the touch pad 210, the controller 130 may provide a visual feedback via the first GUI to indicate that a second touch interaction is available. Here, the first touch interaction may, for example, be a drag or flick manipulation, and the second touch interaction may, for example, be a rotation manipulation.

Meanwhile, if a signal according to a movement of the remote control apparatus 200 is received, the controller 130 may control the second GUI corresponding to the movement of the remote control apparatus 200 to be displayed on the display 110. If a location information signal regarding a touch input of the touch pad 210 of the remote control apparatus 200 is received, the first GUI corresponding to the location information may be displayed. In particular, the first GUI corresponding to the touch input may be displayed within the second GUI corresponding to the movement of the remote control apparatus 200. In particular, the second GUI may, for example, be configured to correspond to the shape of the touch pad 210. The second GUI may be configured in various ways. The first GUI and the second GUI will be described later.

The controller 130 may, for example, determine an inputtable function at a touch location based on the type of an object displayed on the area where the second GUI is located, provide a visual feedback to the first GUI to guide a user to a touch interaction for performing the determined function, change the shape of the second GUI based on the determined function, and provide a visual feedback to the first GUI to correspond to the changed second GUI.

If a signal corresponding to a touch interaction input through a remote control apparatus is received, the controller 130 may perform a function corresponding to the received signal and provide an animation effect according to the performance of the function via the first GUI.

FIG. 2B is a block diagram illustrating an example detailed configuration of a display apparatus 100′ according to another example embodiment. Referring to FIG. 2B, the display apparatus 100′ includes the display 110, the communicator 120, the controller 130, a user interface 140, a storage 150, an audio processor 160, a video processor 170, a speaker 180, a button 181, a camera 182, and a microphone 183. The descriptions regarding the elements of 2B which are overlapped with those of FIG. 2A will not be provided.

The controller 130 controls overall operations of the display apparatus 100 using various programs stored in the storage 150.

Specifically, the controller 130 includes a RAM 131, a ROM 132, a main CPU 133, a graphic processor 134, first to nth interface 135-1-135-n, and a bus 136.

The RAM 131, the ROM 132, the main CPU 133, the graphic processor 134, the first to the nth interface 135-1135-n, etc. may be interconnected through the bus 136.

The first to the nth interface (135-1 to 135-n) are connected to the above-described various elements. One interface may be network interface which is connected to an external apparatus via network.

The main CPU 133 may access the storage 150, and may perform booting using an Operating System (O/S) stored in the storage 150. In addition, the main CPU 133 may perform various operations using various programs stored in the storage 150.

An example of operation is provided herein. The ROM 132 stores a set of commands for system booting. If a turn-on command is input and thus, power is supplied, the main CPU 133 copies O/S stored in the storage 150 in the RAM 131 according to a command stored in the ROM 132, and boots a system by executing the O/S. When the booting is completed, the main CPU 133 copies various application programs stored in the storage 150 in the RAM 131, and executes the application programs copied in the RAM 131 to perform various operations.

The graphic processor 134 generates a screen including various objects such as an icon, an image, a text, etc. using an computing unit (not shown) and a rendering unit (not shown). The computing unit computes property values such as coordinates, shape, size, and color of each object to be displayed according to the layout of the screen using a control command received from an input unit. The rendering unit generates a screen with various layouts including objects based on the property values computed by the computing unit. The screen generated by the rendering unit is displayed in a display area of the display 110.

Meanwhile, the operations of the above-described controller 130 may be performed by a program stored in the storage 150.

The storage 150 stores various data such as, for example, an O/S software module to drive the display apparatus 100′, various channel information, various GUI information, etc.

In this case, the controller 130 may display the first GUI and the second GUI based on information stored in the storage 150.

The user interface 140 receives various user interactions. Here, the user interface 140 may be realized in various forms according to example embodiments of the display apparatus 100′. If, for example, the display apparatus 100′ is realized as a digital TV, the user interface 140 may be realized as a remote control receiver which receives a remote control signal from the remote control apparatus 200, a camera 182 which detects a user motion, a microphone 183 which receives a user voice, etc. Alternatively, if the display apparatus 100′ is realized as a touch-based mobile terminal, the user interface 140 may be realized in the form of touch screen which forms an inter-layer structure with respect to a touch pad. In this case, the user interface 140 may be used as the above-described display 110.

The audio processor 160 performs processing with respect to audio data. The audio processor 160 may, for example, perform various processing such as decoding, amplification, noise filtering, etc. with respect to audio data.

The video processor 170 performs processing with respect to video data. The video processor 170 may, for example, perform various image processing such as decoding, scaling, noise filtering, frame rate conversion, resolution conversion, etc. with respect to video data.

The speaker 180 outputs not only various audio data processed by the audio processor 160 but may also output various alarm sounds or voice messages, etc.

The button 181 may be realized as various types of buttons such as a mechanical button, the touch pad 210, a wheel, etc. which are formed on the front, side, or rear of the exterior of a main body.

The camera 182 photographs a still image or a moving image according to a user's control. The camera 182 may be realized as a plurality of cameras such as a front camera, a rear camera, etc. The microphone 183 receives a user voice or other sounds and converts the same into audio data.

Hereinafter, a basic configuration and various example embodiments will be described for better understanding.

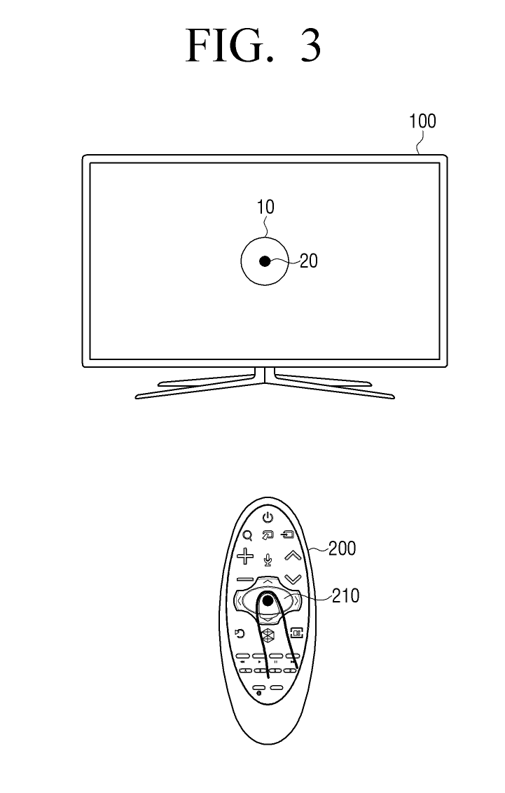

FIG. 3 is a screen displaying a GUI according to an example embodiment.

Referring to FIG. 3, if a signal corresponding to a user's touch input is received from the remote control apparatus 200 having the touch pad 210, the display apparatus 100 may display a first GUI 20 corresponding to the received signal. If the first GUI 20 is displayed, a second GUI 10 to guide a user to a touch location on the touch pad 210 may also be displayed. Here, the second GUI 10 may be displayed such that it corresponds to the movement of the remote control apparatus 200.

Meanwhile, the second GUI 10 may, for example, be displayed such that it corresponds to the shape of the touch pad 210 of the remote control apparatus 200. The second GUI 10 may be displayed in various forms. For example, even if the touch pad 210 is the form of circle, the second GUI 10 may be in the form of square or diamond. If the shape of the second GUI is different from that of the touch pad 210, a touch location according to a user's touch input may be mapped to the shape of the touch pad 210 appropriately and displayed.

Meanwhile, the first GUI 20 or the second GUI 10 may disappear from the screen if there is no touch input from a user or no movement of the remote control apparatus 200 for a predetermined time.

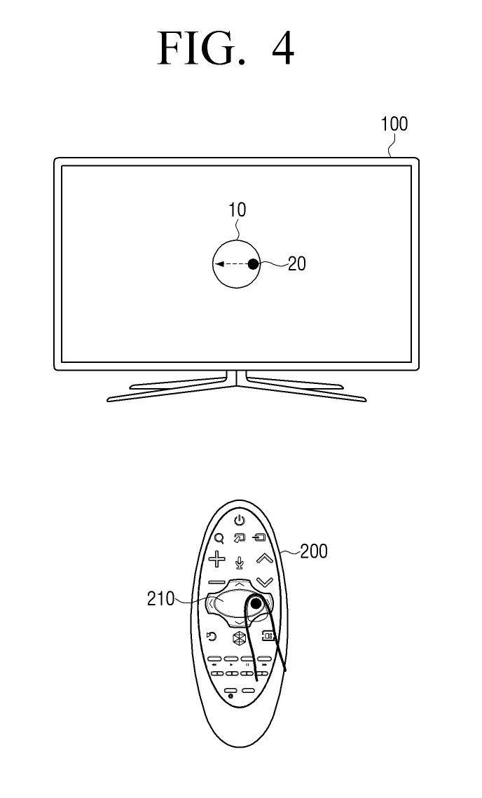

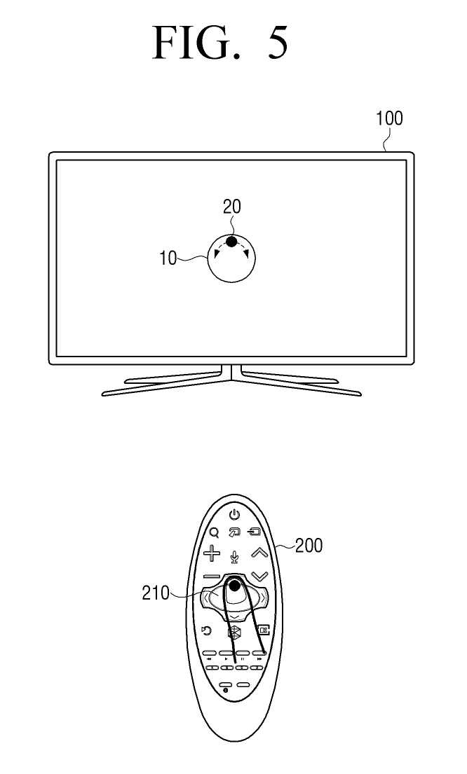

FIGS. 4 and 5 are views illustrating that a visual feedback is provided to the first GUI according to various example embodiments.

FIG. 4 is a view illustrating an example of when a user touches the right side of the touch pad 210 of the remote control apparatus 200 according to an example embodiment. In this case, the display apparatus 100 may receive location information of the user's touch input, and determine whether there is an executable touch interaction at the corresponding touch location based on the received location information and if so, what is the type of the touch interaction.

If it is determined that there is a touch interaction at the corresponding location, the controller 130 may provide a visual feedback to the first GUI 20 to indicate that a specific function is executable according, for example, to a flip manipulation in a left direction.

FIG. 4 illustrates display of an arrow in a dotted line in the left direction from the first GUI 20, but this is only an example. The visual feedback of moving the first GUI 20 itself in the left direction may be provided, for example.

A user may perform a specific function according to a flip manipulation, and the display apparatus 100 may further display what function corresponds to the flip manipulation. In addition, FIG. 4 illustrates that an executable touch interaction on the right side of the touch pad 210 is only a flip manipulation in the left direction, but another function may be performed according to the manipulation of pressing the touch pad 210 for a long time, in which case, both of the functions may be displayed. Not only a flip manipulation but also a drag manipulation may be used to perform another function.

FIG. 5 is a view illustrating an example of when a user touches an upper part of the touch pad 210 of the remote control apparatus 200 according to another example embodiment. In this case, as shown in FIG. 4, the display apparatus 100 may determine which touch interaction is allocated at the user's touch location and what the type of the interaction is.

FIG. 5 illustrates a visual feedback according to a rotation manipulation in a clockwise direction and a counterclockwise direction is provided, and a user may select one of the manipulations or none of the manipulations. In addition, the display apparatus 100 may further display which function corresponds to a rotation manipulation.

According to FIGS. 4 and 5, it appears that a user's touch location is divided into up, down, left and right directions. However, the user's touch location may be divided by a plurality concentric circles and different visual feedbacks may be provided according to each area. For example, different visual feedbacks may be provided depending on whether the inside of the touch pad 210 is touched or the border of the touch pad 210 is touched.

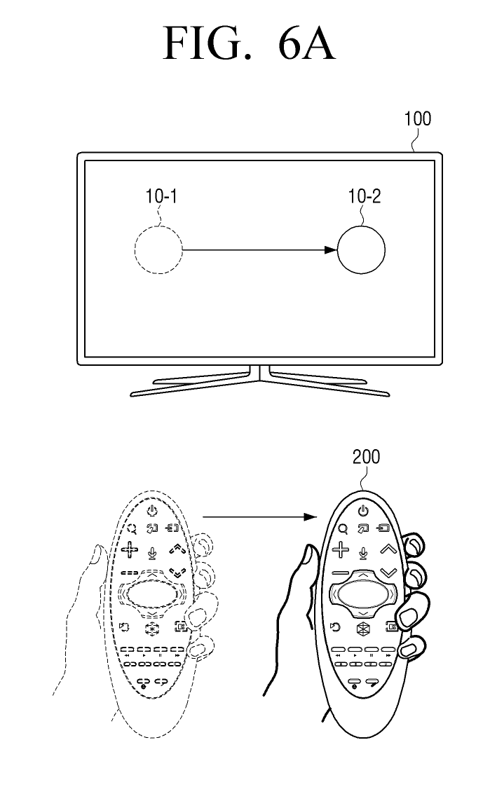

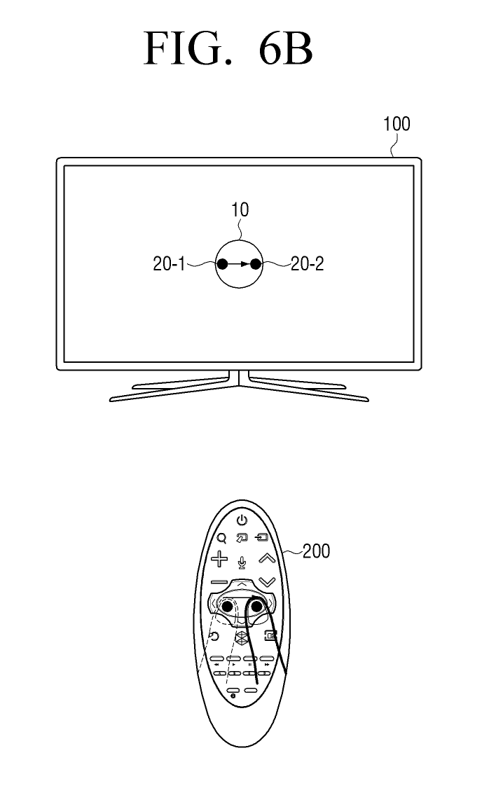

FIG. 6 is a view provided to explain a method of manipulating a remote control apparatus for better understanding of an example embodiment.

FIG. 6A is a view illustrating that the second GUI 10 moves according to a movement of the remote control apparatus 200. If there is no movement of the remote control apparatus 200, the second GUI 10 may disappear after a predetermined time in order to minimize interference with a user's viewing.

Subsequently, if a movement of the remote control apparatus 200 is detected, the second GUI 10 may be displayed. The remote control apparatus 200 may include a motion sensor. Coordinate values in a three-dimensional space of the remote control apparatus 200 may be generated as a signal by the motion sensor, and the generated signal may be transmitted to the display apparatus 100.

The display apparatus 100 may change the location of the second GUI 10 according to a relative movement of the remote control apparatus 200 and display the second GUI 10. In other words, the display apparatus 100 may display the second GUI 10 such that as the location of the remote control apparatus 200 changes, the second GUI moves from the location of the second GUI 10-1 to the location of the second GUI 10-2.

The distance where the second GUI 10 moves according to the change in the movement of the remote control apparatus 200 may be set by a user. For example, if the remote control apparatus 200 moves by 1 m, the second GUI 10 may set to move by 10 cm.

Meanwhile, if a user does not touch the touch pad 210 of the remote control apparatus 200, the first GUI 20 is not illustrated in FIG. 6A. However, this is only an example, and the first GUI 20 may be displayed along with the second GUI 10. In addition, even if there is no movement of the remote control apparatus 200 for a predetermined time, the second GUI 10 may not disappear.

FIG. 6B is a view illustrating that the first GUI 20 moves according to the change in a touch input of the touch pad 210. If there is a user's touch input, the second GUI 10 may be displayed without a movement of the remote control apparatus 200, but this is only an example. Only the first GUI 20 may be displayed even if the second GUI 10 is not displayed. Hereinafter, it is assumed that the second GUI 10 is displayed along with the first GUI 20.

The first GUI 20 may not be displayed until there is a user's touch input in order to minimize interference with the user's viewing. Subsequently, if there is a user's touch input, the first GUI 20 may be displayed. If there is a change in the user's touch input, a signal according to the changed touch location may be transmitted to the display apparatus 100, and the display apparatus 100 may display the first GUI 20 by changing the location of the first GUI 20 from the location of the first GUI 20-1 to the location of the first GUI 20-2.

Hereinafter, an example embodiment based on the relative locations of the first GUI 20 and the second GUI 10 will be described.

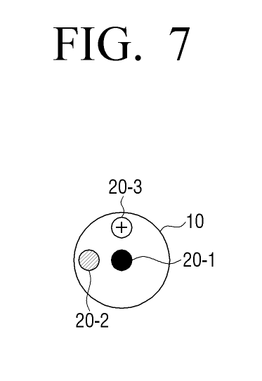

FIG. 7 is a view provided to explain a visual feedback according to an example embodiment.

In FIG. 7, at least one of the shape and color of the first GUI 20 may be displayed differently according to a user's touch location.

If a user touches the center of the touch pad 210 and the first GUI 20-1 is located at the center, the first GUI 20-1 may be displayed in the form of a black circle. In particular, touching the center of the touch pad 210 may be set as an OK signal. For example, the display apparatus 100 may generate an OK signal when an input signal according to the manipulation of double-clicking the center of the touch pad 210 is received as if the left button of a mouse is double-clicked. The first GUI 20-1 may be displayed in the form of a black circle and guide a user to double-click the current touch location if the user wishes to generate an OK signal.

Meanwhile, the first GUI 20-2 may be displayed to be more vague than the first GUI 20-1, which may indicate that there is no executable touch interaction at the corresponding touch location. A user may find a vague area just like the first GUI 20-2 and touch another touch location.

In addition, if there are a plurality of executable touch interactions at a corresponding touch location, the first GUI 20-3 may be displayed. In this case, if a user's touch is maintained, a visual feedback according to a plurality of touch interactions may be provided. For example, a visual feedback to lead to a rotation manipulation in a clockwise direction or a counterclockwise direction as shown in FIG. 5 may be provided. The user may delete one of a plurality of touch interactions or allocate another function.

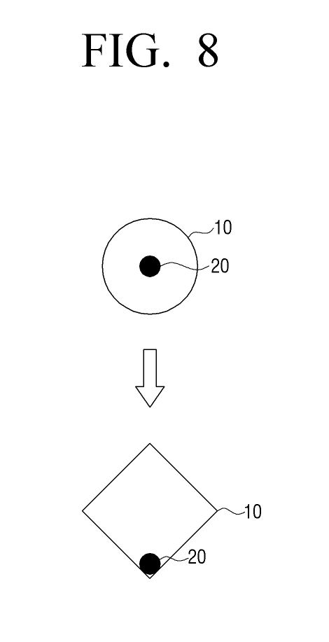

FIG. 8 is a view provided to explain that a visual feedback is provided from a second GUI according to an example embodiment.

In FIG. 8, if a user's touch location is at the center of the touch pad 210, the first GUI 20 and the second GUI 10 in the form of a circle may be displayed. Meanwhile, as described above, the first GUI 20 and the second GUI 10 may not be in the form of a circle.

Subsequently, if a user's touch location is at the lower part of the touch pad 210, the form of the second GUI 10 may be changed from a circle to a diamond, and the first GUI 20 may be displayed at the lower part of the second GUI 10. In this case, a user may be provided with various interactions. For example, a user may perform the manipulation of flicking in the upper direction from the first GUI 20, the manipulation of rotating in a counterclockwise direction, the manipulation of changing a touch locating along the border of the second GUI 10 in the form of a diamond, etc.

In FIG. 8, the second GUI 10 is illustrated in the form of a diamond, but the second GUI 10 may be provided in other forms such as a square, a triangle, etc., and the shape of color of the first GUI 20 may also be changed as described above with reference to FIG. 7. A new touch interaction may be set according to the changed shape, etc.

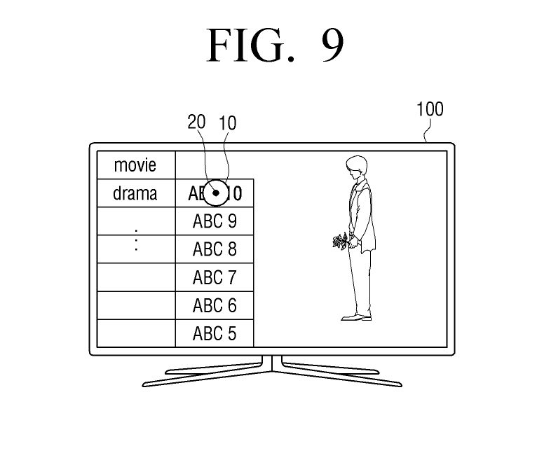

FIG. 9 is a view provided to explain how an object displayed at an area where a second GUI is located is controlled according to an example embodiment.

In FIG. 9, the second GUI 10 is located at ACB 10 of a drama tab. The first GUI 20 inside the second GUI 10 is illustrated as a black circle, and if a double-click manipulation is set to be an OK signal as described above with reference to FIG. 7, a user may watch ABC 10 by double-clicking the current touch location.

Meanwhile, in order to provide a user with a clear visual feedback, only the first GUI 20 may be displayed inside the second GUI 10, and an object which is overlapped with the area where the second GUI 10 is located may not be displayed. However, this is only an example. The object may be displayed in a transparent manner so as to partially overlapped.

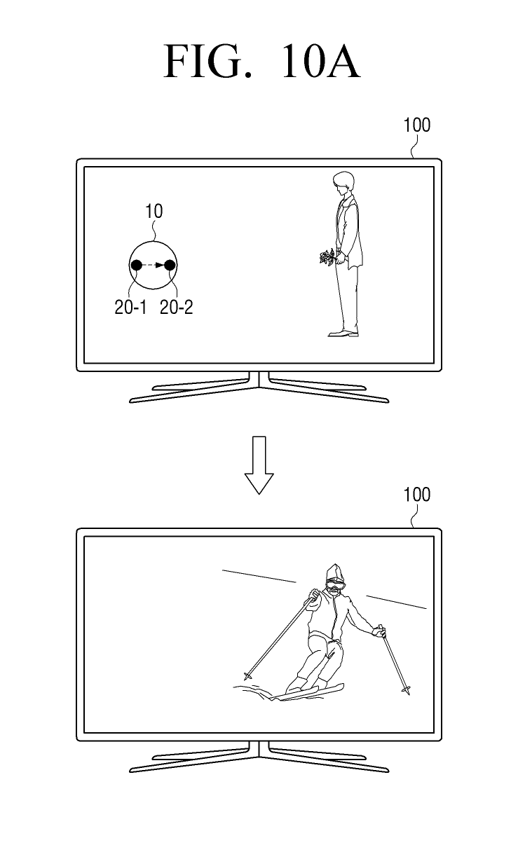

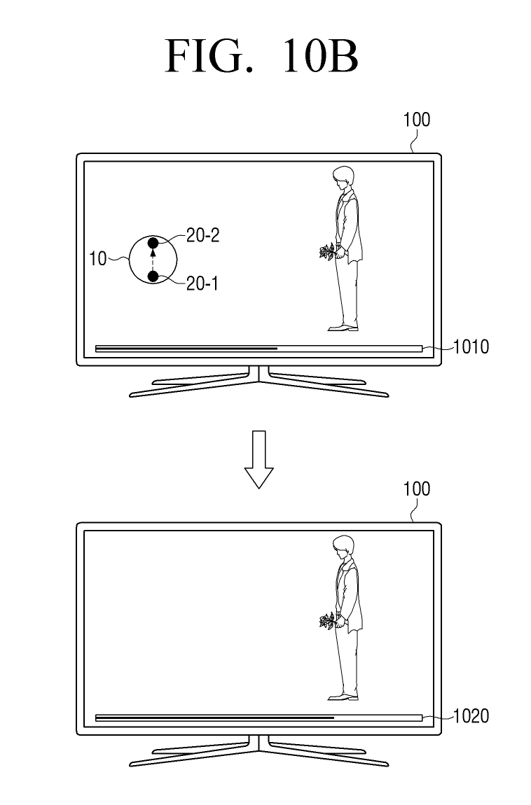

FIG. 10 is a view provided to explain a touch interaction according to various example embodiments.

Referring to FIG. 10A, a user may change channels through a flick manipulation of flicking a touch location of the touch pad 210 from a left side to a right side. Through the flick manipulation from the left side to the right side, moving from the first GUI 20-1 to the first GUI 20-2 is displayed and channels are changed. As the channels are changed, the first GUI 20 and the second GUI 10 may not be displayed, but this is only an example. Even after the channels are changed, the GUIs may be displayed for a predetermined time so that a user's additional input can be received.

Referring to FIG. 10B, a user may change volume through a flick manipulation of flicking a touch location of the touch pad 210 from a lower side to an upper side. Through the flick manipulation from the lower side to the upper side, moving from the first GUI 20-1 to the first GUI 20-2 is displayed and volume is changed. As the volume is changed, the first GUI 20 and the second GUI 10 may not be displayed, but this is only an example. Even after the volume is changed, the GUIs may be displayed for a predetermined time so that a user's additional input can be received.

If a signal for changing volume is received, the display apparatus 100 may display volume control UIs 1010, 1020. FIG. 10B illustrates that the flick manipulation of flicking from a lower part to an upper part corresponds to a volume-up function and accordingly, displays that volume is changed from the volume control UI 1010 to the volume control UI 1020.

Meanwhile, FIG. 10 is only an example embodiment, and another example embodiment may be provided. For example, through the flick manipulation from down to up, a channel-up function or a volume-down function instead of the volume-up function may be performed. In addition, the volume control UIs 1010, 1020 may or may not be displayed. In addition, a drag manipulation rather than the flick manipulation may perform the same function.

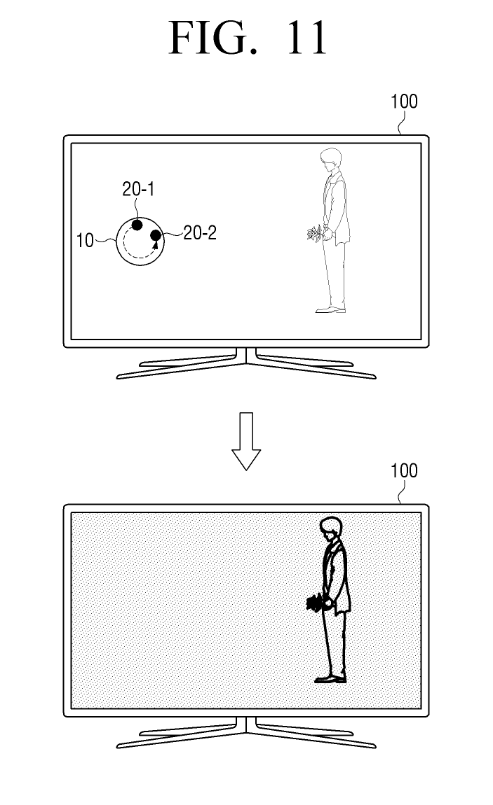

FIG. 10 describes general functions such as changing channels or controlling volume, and FIG. 11 will describe how to use the touch pad 210 by enhancing its usability.

FIG. 11 is a view provided to explain a method of using a touch pad by increasing its usability according to an example embodiment.

In FIG. 11, a user touches the upper part of the touch pad 210 and accordingly, the display apparatus 100 may provide a visual feedback in a counterclockwise direction. In addition, while the visual feedback in the counterclockwise direction is provided, a guide to the corresponding function may be provided simultaneously.

FIG. 11 is a view illustrating that if there is a user's touch interaction corresponding to a visual feedback, that is, if there is a touch interaction from the first GUI 20-1 to the first GUI 20-2, the content which is currently displayed becomes dark. In other words, further functions, not just the existing basic functions of changing channels or controlling volume, may be provided, and a user may change various settings such as chroma, luminosity, brightness, etc. In addition, the user may further display which function corresponds to a user's touch interaction, improving user convenience.

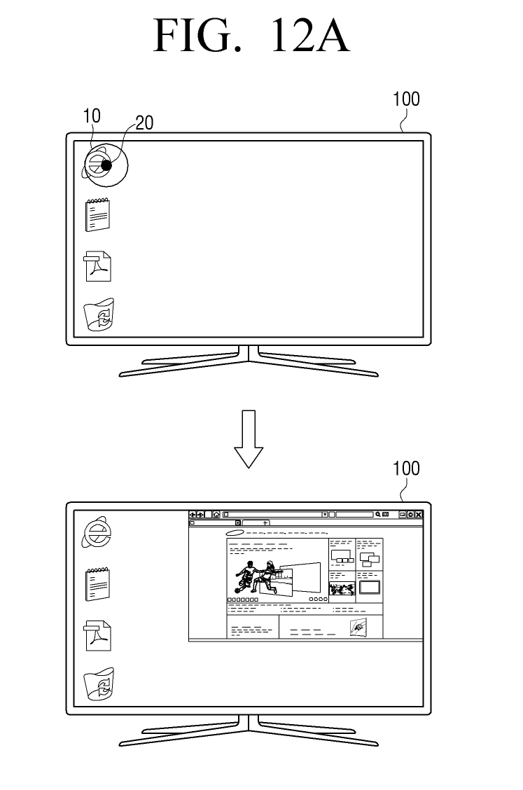

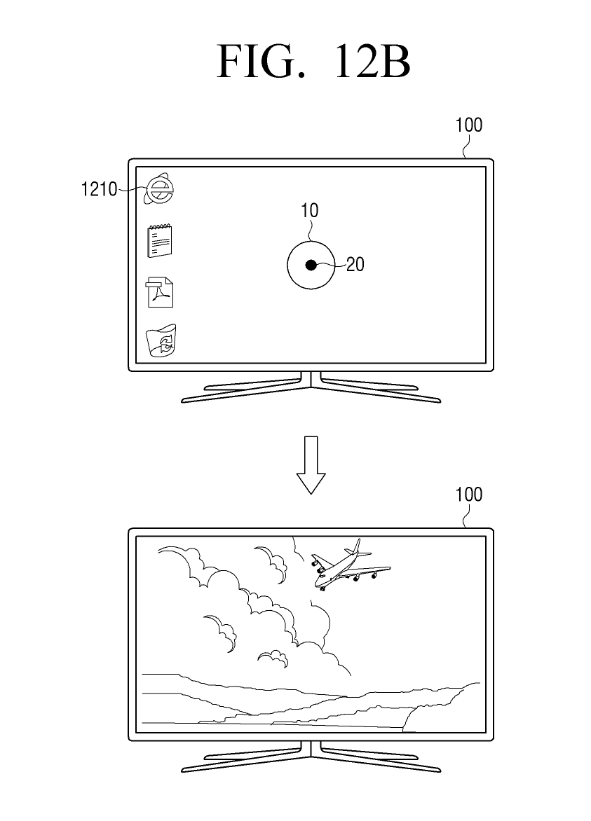

FIG. 12 is a view provided to explain an operation of a second GUI with respect to an object according to various example embodiments.

FIG. 12A is a view provided to explain that the second GUI 10 selects an object according to an example embodiment. In other words, if the remote control apparatus 200 is moved such that the second GUI 10 overlaps with an object which is currently displayed and then, an OK is input, a function corresponding to the selected object may be performed.

FIG. 12A illustrates a general PC screen, but this is only an example. A UI screen including a GUI icon may also be included. In addition, though not illustrated, the manipulation of locating the second GUI 10 on an object and touching the object once may cancel the execution of a function corresponding to the object. In other words, various functions may be performed according to a touch interaction even if the second GUI 10 is overlapped on to the same object and thus, a user may perform various manipulations.

FIG. 12B is a view provided to explain a case where the second GUI 10 is located at an area in which no object is displayed and an OK is input according to another example embodiment. In other words, four objects may be displayed on the display apparatus 100, the second GUI 10 may be located at the center area where no object is displayed, and an OK may be input. In this case, a screen saver may be displayed.

In other words, even with the same touch interaction by a user, different functions may be provided depending on which part of the display apparatus 100 the second GUI 10 is located. In addition, the controller 130 may provide a visual feedback and display a corresponding function simultaneously. Accordingly, there is no need for the user to be aware of all touch interactions and corresponding functions, improving user convenience.

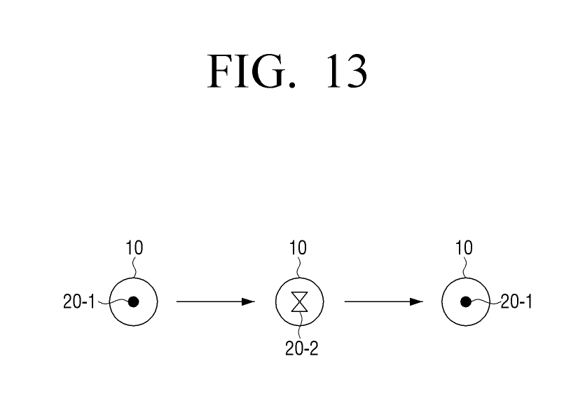

FIG. 13 is a view illustrating change of a second GUI when there is a delay in time for executing a function according to an example embodiment.

It may take time for some specific functions of the display apparatus 100 to be executed depending on various environments. For example, a time delay may occur for various reasons such as Internet speed, content volume, etc. In this case, the time delay may be notified to a user by changing the shape of the first GUI from the first GUI 20-1 to the first GUI 20-2.

Once the display apparatus 100 is ready to execute a function, the first GUI 20-2 may be changed to the first GUI 20-1 to indicate that the time delay has ended. Here, FIG. 13 illustrates that the shape of the first GUI 20 is changed, but it will be understood that the shape of the second GUI 10 may also be changed. Further, not only the shape but also the color may be changed.

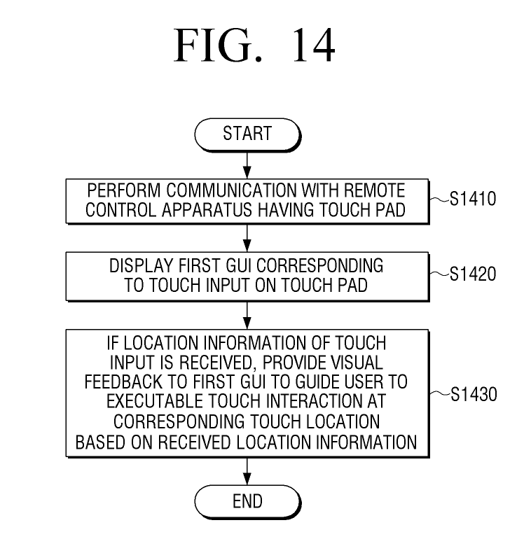

FIG. 14 is a flowchart provided to explain a method of controlling a display apparatus according to an example embodiment.

As shown in FIG. 14, a display apparatus performs communication with a remote control apparatus (S1410). If an input signal is received from the remote control apparatus, the display apparatus displays a first GUI corresponding to the touch input on a touch pad (S1420). In this case, the signal received from the remote control apparatus may be a touch input signal or a signal corresponding to a movement of the remote control apparatus. If the received signal is a signal corresponding to a movement of the remote control apparatus, the second GUI may be displayed.

If location information of the touch input is received, a visual feedback is provided to the first GUI to guide a user to an executable touch interaction at the corresponding touch location based on the received location information (S1430). As described above, a visual feedback may be provided by not only the first GUI but also the second GUI. Meanwhile, the shape of the second GUI may be configured to correspond to the shape of the touch pad.

The step of providing a visual feedback (S1430) may include providing a visual feedback by changing at least one of the shape and color of the first GUI according to at least one of whether a touch interaction is allocated at the touch location or the type of a touch interaction allocated at the touch location. For example, an additional visual feedback may be provided by changing the shape of the first GUI to a circle or a square or changing the color of the first GUI to gray.

The step of providing a visual feedback (S1430) may include, if it is determined that the touch location is within the touch pad, indicating that a first touch interaction is available, and if it is determined that the touch location is on the border of the touch pad, providing a visual feedback to the first GUI to indicate that a second touch interaction is available. The first touch interaction may, for example, be a drag or a flick manipulation, and the second touch interaction may be a rotation manipulation.

The step of providing a visual feedback (S1430) may, for example, include determining an inputtable function at the touch location based on the type of an object which is displayed on an area where the second GUI is located, and providing a visual feedback via the first GUI to guide a user to a touch interaction for performing the determined function. In addition, the shape of the second GUI may be changed to perform the determined function, and a visual feedback may be provided to the first GUI to correspond to the changed second GUI.

The step of providing a visual feedback (S1430) may include, if information regarding a user's touch interaction is received according to the guide, performing a function corresponding to the touch interaction information and providing a visual feedback to the first GUI according to the development of the function performed.

According to the above-described various example embodiments, a user may perform various touch interactions using a touch pad of a remote control apparatus, thereby improving user convenience. In addition, as descriptions regarding functions corresponding to various touch interactions are provided, a user may use various functions without paying extra attention to the functions.

Meanwhile, the methods according to the various example embodiments may be programmed and stored in various storage media. Accordingly, the above methods according to the various example embodiments may be realized in various types of electronic apparatuses which execute the storage media.

Specifically, according to an example embodiment, a non-transitory computer readable medium storing a program for performing the steps of performing communication with a remote control apparatus having a touch pad, displaying a first GUI corresponding to a touch input on a touch pad, and in response to receiving location information of the touch input, providing a visual feedback to the first GUI to guide a user to an executable touch interaction at the corresponding touch location based on the received location information may be provided.

The non-transitory recordable medium refers to a medium which may store data semi-permanently rather than storing data for a short time, such as register, cache, memory, etc. and is readable by an apparatus. Specifically, the above-described various applications and programs may, for example, be stored and provided in a non-transitory recordable medium such as, for example, CD, DVD, hard disk, Blu-ray disk, USB, memory card, ROM, etc.

The foregoing embodiments and advantages are merely examples and are not to be construed as limiting the present disclosure. The present teaching can be readily applied to other types of apparatuses. Also, the description of the example embodiments of the present disclosure are intended to be illustrative, and not to limit the scope of the claims, and many alternatives, modifications, and variations will be apparent to those skilled in the art without departing from the true spirit and full scope of the appended claims.

What is claimed is:

1. A display apparatus, comprising:
a communicator configured to communicate with a remote control apparatus having a touch pad;
a display configured to display a first GUI based on detection of a touch input on the touch pad; and
a controller configured to provide a visual feedback via the first GUI in response to receiving location information of the touch input to guide an executable touch interaction at a corresponding touch location based on the received location information.

2. The apparatus as claimed in claim 1, wherein the controller is configured to provide the visual feedback by changing at least one of a shape and a color of the first GUI according to at least one of whether a touch interaction is allocated at the touch location and a type of a touch interaction allocated at the touch location.

3. The apparatus as claimed in claim 1, wherein the controller is configured to control the display to display a second GUI to guide the touch location on the touch pad and to display the first GUI inside the second GUI based on location information of the touch input.

4. The apparatus as claimed in claim 3, wherein the second GUI corresponds to a shape of the touch pad.

5. The apparatus as claimed in claim 3, wherein the controller is configured, in response to determining that the touch location is within the touch pad, to indicate that a first touch interaction is available, and in response to determining that the touch location is on a border area of the touch pad, provides a visual feedback via the first GUI to indicate that a second touch interaction is available.

6. The apparatus as claimed in claim 5, wherein the first touch interaction is a drag or flick manipulation, and the second touch interaction is a rotation manipulation.

7. The apparatus as claimed in claim 3, wherein the controller is configured to move a location of the second GUI based on a signal corresponding to a movement of the remote control apparatus received from the remote control apparatus, and to display the second GUI.

8. The apparatus as claimed in claim 3, wherein the controller is configured to determine an inputtable function at the touch location based on a type of an object displayed on an area where the second GUI is located, and to provide a visual feedback via the first GUI to guide a touch interaction for performing the determined function.

9. The apparatus as claimed in claim 8, wherein the controller is configured to change a shape of the second GUI based on the determined function, and to provide a visual feedback via the first GUI to correspond to the changed second GUI.

10. The apparatus as claimed in claim 1, wherein the controller, in response to receiving a signal corresponding to a touch interaction input through the remote control apparatus, is configured to perform a function corresponding to the received signal, and to provide an animation effect according to the performed function via the first GUI.

11. A controlling method of a display apparatus, comprising:
performing communication with a remote control apparatus having a touch pad; and
displaying a first GUI corresponding to a touch input on the touch pad, in response to receiving a signal according to a touch input on the touch pad, wherein displaying the first GUI comprises providing a visual feedback via the first GUI to guide an executable touch interaction at a corresponding touch location based on location information of the touch input.

12. The method as claimed in claim 11, wherein displaying the first GUI comprises providing the visual feedback by changing at least one of a shape and a color of the first GUI according to at least one of whether a touch interaction is allocated at the touch location and what type of a touch interaction is allocated at the touch location.

13. The method as claimed in claim 11, further comprising:
displaying a second GUI to guide the touch location on the touch pad, wherein displaying the first GUI comprises displaying the first GUI inside the second GUI based on location information of the touch input.

14. The method as claimed in claim 13, wherein the second GUI corresponds to a shape of the touch pad.

15. The method as claimed in claim 13, wherein displaying the first GUI comprises, in response to determining that the touch location is within the touch pad, indicating that a first touch interaction is available, and in response to determining that the touch location is on a border area of the touch pad, providing a visual feedback via the first GUI to indicate that a second touch interaction is available.

16. The method as claimed in claim 15, wherein the first touch interaction is a drag or flick manipulation, and the second touch interaction is a rotation manipulation.

17. The method as claimed in claim 13, wherein displaying the second GUI comprises moving a location of the second GUI based on a signal corresponding to a movement of the remote control apparatus received from the remote control apparatus, and displaying the second GUI.

18. The method as claimed in claim 13, wherein displaying the first GUI comprises determining an inputtable function at the touch location based on a type of an object displayed on an area where the second GUI is located, and providing a visual feedback via the first GUI to guide a touch interaction for performing the determined function.

19. The method as claimed in claim 18, further comprising:
changing a shape of the second GUI based on the determined function, wherein displaying the first GUI comprises providing a visual feedback via the first GUI to correspond to the changed second GUI.

20. The method as claimed in claim 11, further comprising:
in response to receiving a signal indicative of a touch interaction input through the remote control apparatus, performing a function corresponding to the received signal; and
providing an animation effect according to the performed function via the first GUI.
